(19) United States
(12) Patent Application Publication
(10) Pub. No.: US 2026/0335763 A1
(43) Pub. Date: Oct. 29, 2026

(54) METHOD AND APPARATUS FOR CONTROLLING VIRTUAL OBJECTS, DEVICE, AND COMPUTER READABLE STORAGE MEDIUM

(71) Applicant: Century Games Pte. Ltd., Singapore (SG)

(72) Inventors: Congnan Huang, Fuzhou City (CN); Dandan Chen, Fuzhou City (CN); Liangqing Sun, Fuzhou City (CN); Hao Sun, Fuzhou City (CN)

(21) Appl. No.: 19/559,651

(22) Filed: Mar. 6, 2026

(30) Foreign Application Priority Data
Apr. 25, 2025 (CN) 202510532390.5

(51) Int. Cl. A63F 13/52

(52) U.S. Cl. CPC A63F 13/52

(57) ABSTRACT

The present disclosure discloses a method for controlling virtual objects. The method includes: displaying a first virtual object performing a scene exploration task in a virtual scene; in response to a move operation on the first virtual object, controlling the first virtual object to move in the virtual scene in a direction corresponding to the move operation; in a case where a second virtual object in a first state is present in the virtual scene, controlling the first virtual object to change a state of the second virtual object to a second state, wherein the second state is different from the first state; in a case where the second virtual object is in the second state, displaying the second virtual object in the second state following the first virtual object, wherein the second virtual object assists the first virtual object in performing the scene exploration task.

### CROSS-REFERENCE TO RELATED APPLICATIONS

This application claims the benefit of Chinese patent application CN202510532390.5 filed on Apr. 25, 2025 and granted on Jan. 30, 2026, which is incorporated herein by reference.

### TECHNICAL FIELD

Embodiments of the present disclosure relate to the field of computer technologies, and in particular, to a method and apparatus for controlling virtual objects, a device, and a computer-readable storage medium.

### BACKGROUND

With the continuous development of computer technologies, the types of electronic games are becoming increasingly diverse, such as shooting games, role-playing games, business strategy games, and so on. In electronic games, virtual objects can be controlled to move around in a virtual scene, for example, the virtual objects are controlled to move in the virtual scene.

In the related art, the virtual scene is covered with granular coverings (such as sand and snow), and a game object can control the virtual object to move within the virtual scene in order to eliminate the granular coverings.

However, in the aforementioned method, the granular coverings are eliminated by the virtual object, resulting in low efficiency in eliminating the granular coverings. Moreover, the method for controlling virtual objects is relatively simple and lacks flexibility, resulting in poor interactivity in the game.

### SUMMARY

The embodiments of the present disclosure provide a method and apparatus for controlling virtual objects, a device, and a readable storage medium. The technical solutions are as follows.

In one aspect of the embodiments of the present disclosure, a method for controlling virtual objects is provided. The method includes: displaying a first virtual object performing a scene exploration task in a virtual scene; in response to a move operation on the first virtual object, controlling the first virtual object to move in a direction corresponding to the move operation in the virtual scene; in a case where a second virtual object in a first state is present in the virtual scene, controlling the first virtual object to change a state of the second virtual object to a second state, wherein the second state is different from the first state; and in a case where the second virtual object is in the second state, displaying the second virtual object in the second state following the first virtual object, wherein the second virtual object assists the first virtual object in performing the scene exploration task.

In another aspect of the embodiments of the present disclosure, an apparatus for controlling virtual objects is provided. The apparatus includes:
a displaying module, configured to display a first virtual object performing a scene exploration task in a virtual scene; and
a controlling module, configured to control the first virtual object to move in a direction corresponding to a move operation in the virtual scene in response to the move operation on the first virtual object; wherein
the controlling module is further configured to, in a case where the second virtual object in the first state is present in the virtual scene, control the first virtual object to change a state of the second virtual object to a second state, wherein the second state is different from the first state; and
the displaying module is further configured to, in a case where the second virtual object is in the second state, display the second virtual object in the second state following the first virtual object, wherein the second virtual object assists the first virtual object in performing the scene exploration task.

In a possible embodiment, the virtual scene is covered with granular coverings, and the first virtual object holds a first virtual prop, wherein the first virtual prop is used to eliminate granular coverings within an application scope of the first virtual prop;
the controlling module is configured to control the first virtual object to change, through the first virtual prop, a state of the second virtual object to the second state in a case where a second virtual object in a first state is present in the virtual scene, and the second virtual object in the first state is located within the application scope of the first virtual prop; and
the displaying module is configured to, in a case where the second virtual object is in the second state, display the second virtual object following the first virtual object, wherein the second virtual object is in the second state and holds a second virtual prop, wherein the second virtual prop is used to eliminate granular coverings within an application scope of the second virtual prop, and the second virtual object assists, through the second virtual prop, the first virtual object in performing the scene exploration task.

In a possible embodiment, the application scope of the first virtual prop is determined based on a position of the first virtual object, a first length, and a first angle, wherein the first length and the first angle are determined based on a target quantity, wherein the target quantity is the quantity of virtual objects whose state is changed by the first virtual object.

In a possible embodiment, the controlling module is configured to control the first virtual object to change, through the first virtual prop, the state of the second virtual object to a third state in a case where the second virtual object in the first state is present in the virtual scene, the second virtual object in the first state is located within the application scope of the first virtual prop, and a first duration has elapsed, wherein the third state is between the first state and the second state; and in response to a second duration having elapsed, controlling the first virtual object to change, through the first virtual prop, the state of the second virtual object to the second state.

In a possible embodiment, the virtual scene is covered with granular coverings; the first virtual object holds a first virtual prop, wherein the first virtual prop is used to eliminate granular coverings within an application scope of the first virtual prop; and the apparatus further includes: a determining module, configured to determine the application scope of the first virtual prop based on a position of the first virtual object after movement; wherein displaying module is further used to display the first virtual object eliminating, through the first virtual prop, the granular coverings within the application scope of the first virtual prop.

In a possible embodiment, the virtual scene is covered with granular coverings; the first virtual object holds a first virtual prop, wherein the first virtual prop is used to eliminate granular coverings within an application scope of the first virtual prop; and after the first virtual object changes the state of the second virtual object to the second state, the application scope of the first virtual prop held by the first virtual object is larger than that before the first virtual object changes the state of the second virtual object to the second state.

In a possible embodiment, the apparatus further includes: an adjusting module, configured to, in a case where the number of the second virtual objects following the first virtual object is greater than a first threshold, adjust application scopes of the second virtual props held by the second virtual objects, wherein adjusted application scopes of the second virtual props are larger than their original application scopes before adjustment.

In a possible embodiment, the displaying module is further configured to, in a case where the number of the second virtual objects following the first virtual object reaches a second threshold, display a third virtual object acquired by combining the second virtual objects of the second threshold, wherein the third virtual object holds a third virtual prop, wherein the third virtual prop is used to eliminate granular coverings within an application scope of the third virtual prop, the application scope of the third virtual prop being larger than the sum of the application scopes of the second virtual props held by the second virtual objects of the second threshold.

In a possible embodiment, the displaying module is further configured to display a prompt message in a case where the second virtual object possesses a resource exploration capability and a reference virtual resource that is covered with granular coverings is present in the virtual scene, wherein the prompt message is a message used by the second virtual object for guiding the first virtual object to acquire the reference virtual resource, and a type of the reference virtual resource is corresponding to a type of the second virtual object.

In a possible embodiment, the displaying module is further configured to display granular coverings in a first area as eliminated in response to the first virtual object releasing a first skill towards a target position, and the second virtual object releasing a second skill towards the target position, wherein the first area is determined based on the target position, and the first skill and the second skill belong to different sub-skills within a combination skill.

In another aspect of the embodiments of the present disclosure, a computer device is provided. The computer device includes a processor and a memory. The memory stores at least one program code, which when loaded and executed by the processor, causes the computer device to perform any one of the methods for controlling virtual objects as described above.

In another aspect, a computer-readable storage medium is further provided. The computer-readable storage medium stores at least one program code, which when loaded and executed by a processor, causes a computer to perform any one of the methods for controlling virtual objects as described above.

In another aspect, a computer program or computer program product is further provided. The computer program or the computer program product stores at least one computer instruction, which when loaded and executed by a processor, causes a computer to perform any one of the methods for controlling virtual objects as described above.

The technical solutions according to the embodiments of the present disclosure at least achieving the following beneficial effects:
In the technical solution according to the embodiments of the present disclosure, a game object is capable of controlling a first virtual object performing a scene exploration task to move within a virtual scene. In a case where a second virtual object in a first state is present within the virtual scene, the first virtual object can be controlled to change the state of the second virtual object to a second state. The second virtual object in the second state follows the first virtual object to assist the first virtual object in performing the scene exploration task, thereby accelerating the completion of the scene exploration task by the first virtual object and improving the efficiency of performing the scene exploration task by the first virtual object. In addition, this method enriches the gameplay of the game, increases the interactive fun of the game, thereby enhancing the sense of participation and achievement of the game object in the game, such that the interactivity of the game and user retention are improved.

### BRIEF DESCRIPTION OF DRAWINGS

For clearer descriptions of the technical solutions in the embodiments of the present disclosure, the following briefly describes the accompanying drawings required for describing the embodiments. Apparently, the accompanying drawings in the following description illustrate merely some embodiments of the present disclosure, and those of ordinary skill in the art can still derive other drawings from these accompanying drawings without creative efforts.

FIG. 1 is a schematic diagram of a computer system according to some embodiments of the present disclosure;

FIG. 2 is a flowchart of a method for controlling virtual objects according to some embodiments of the present disclosure;

FIG. 3 is a schematic diagram of a game interface according to some embodiments of the present disclosure;

FIG. 4 is a schematic diagram of a countdown control according to some embodiments of the present disclosure;

FIG. 5 is a schematic diagram of another countdown control according to some embodiments of the present disclosure;

FIG. 6 is a schematic diagram of changing a state of a second virtual object to a second state according to some embodiments of the present disclosure;

FIG. 7 is a schematic diagram of another game interface according to some embodiments of the present disclosure;

FIG. 8 is a structural schematic diagram of an apparatus for controlling virtual objects according to some embodiments of the present disclosure;

FIG. 9 is a structural schematic diagram of a terminal device according to some embodiments of the present disclosure; and

FIG. 10 is a structural schematic diagram of a server according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

It should be noted that the terms “first”, “second”, etc. in this disclosure are used to distinguish similar objects, and are not necessarily used to describe a specific order or sequence. It should be understood that such terms can be interchanged where appropriate, so that the embodiments described in this disclosure can be implemented in an order other than those illustrated or described here. The implementations described in the following exemplary embodiments do not represent all implementations consistent with this disclosure. Instead, they are merely examples of devices and methods consistent with some aspects of this disclosure as detailed in the accompanying claims.

First, abbreviations and key terms involved in the embodiments of the present disclosure are defined.

Virtual scene: refers to a scene provided (or displayed) when an application runs on a terminal device. This virtual scene is created to enable virtual objects to engage in activities. Virtual scenes can be two-dimensional, 2.5-dimensional, or three-dimensional. The virtual scenes can be simulations of the real world, semi-simulations of the real world, or purely fictional scenes. For example, the virtual scene involved in the embodiments of the present disclosure is a three-dimensional virtual scene.

Virtual object: refers to an active object in a virtual scene, which can be a virtual character, virtual animal, anime character, etc. Users can manipulate virtual objects through peripheral components or by clicking on a touch display screen. Each virtual object has its own shape and volume in the virtual scene, occupying a portion of space within the virtual scene. For example, in a case where the virtual scene is a three-dimensional virtual scene, the virtual object is a three-dimensional model created based on animation skeletal technology.

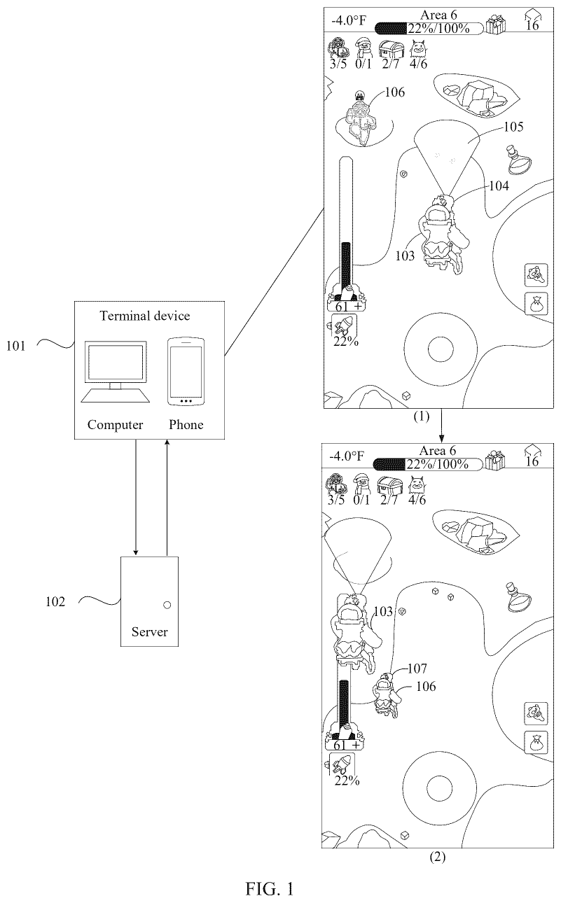

FIG. 1 is a schematic diagram of a computer system according to some embodiments of the present disclosure. As illustrated in FIG. 1, the computer system includes: a terminal device 101 and a server 102. A game client is installed and operated in the terminal device 101. The method for controlling virtual objects according to the embodiments of the present disclosure can be performed by the terminal device 101, or jointly performed by the terminal device 101 and the server 102, which is not limited in embodiments of the present disclosure.

The server 102 is used to provide background services for the game client installed on the terminal device 101. In a possible embodiment, the server 102 undertakes the primary computational work, while the terminal device 101 undertakes the secondary computational work. Alternatively, the server 102 undertakes the secondary computational work, while the terminal device 101 undertakes the primary computational work. Or, the terminal device 101 and the server 102 adopt a distributed computing architecture for collaborative computing.

The game client can be a Third-Person Shooting (TPS) game, a First-Person Shooting (FPS) game, a Multiplayer Online Battle Arena (MOBA) game, a multiplayer shooting survival game, a Massive Multiplayer Online Role-Playing Game (MMO), an Action Role Playing Game (ARPG), a business strategy game, a Virtual Reality (VR) client, an Augmented Reality (AR) client, a three-dimensional map program, a map simulation program, a social networking client, an interactive entertainment client, or the like.

The type of the game client is not limited in the embodiments of the present disclosure. For example, the game client can be an application that needs to be downloaded and installed, a mini-program that does not require downloading, a web application, or the like.

Optionally, the terminal device 101 can be any electronic device product that allows human-computer interaction with users through one or more methods such as a keyboard, a touchpad, a remote control, a voice interaction, or a handwriting device. For example, the terminal device 101 can be a smartphone, a tablet computer, a laptop, a desktop computer, a smart speaker, a smartwatch, a Personal Computer (PC), a mobile phone, a Personal Digital Assistant (PDA), a wearable device, a Pocket PC (PPC), a smart car head unit, a smart television, or the like.

The terminal device 101 can generally refer to one of multiple terminal devices, and the embodiments are exemplified solely by the terminal device 101. Those skilled in the art will appreciate that the number of the terminal devices 101 mentioned above may vary. For instance, there could be just one terminal device 101, or dozens or hundreds, or even more. The embodiments of the present disclosure do not impose any limitations on the number or types of the terminal devices 101.

The server 102 can be a single server, a server cluster consisting of multiple servers, or any of a cloud computing platform or a virtualization center, which is not limited in the embodiments of the present disclosure. The server 102 communicates directly or indirectly with the terminal device 101 via a wired or wireless communication. The server 102 has data receiving, data processing, and data transmitting functions. The server 102 can also have other functions, which is not limited in the embodiments of the present disclosure.

In the method for controlling virtual objects according to the disclosure, the terminal device 101 displays a game interface illustrated in (1) of FIG. 1. The game interface illustrated in (1) of FIG. 1 displays a first virtual object 103 performing a scene exploration task in a virtual scene. The first virtual object 103 holds a first virtual prop 104, wherein an application scope of the first virtual prop 104 is 105. In response to a move operation on the first virtual object 103, the first virtual object 103 is controlled to move in the virtual scene in a direction corresponding to the move operation. In a case where a second virtual object 106 in a first state is present in the virtual scene and the second virtual object 106 is within the application scope 106 of the first virtual prop 104, the first virtual object 103 is controlled to change, through the first virtual prop 104, a state of the second virtual object 106 to a second state, wherein the second state is different from the first state.

In the case where the first virtual object 103 changes the state of the second virtual object 106 to the second state, the game interface illustrated in (2) of FIG. 1 is displayed. Within this game interface, the second virtual object 106, which is in the second state and possesses the second virtual prop 107, is illustrated following the first virtual object 103. The second virtual object 106 assists, through the second virtual prop 107, the first virtual object 103 in performing a scene exploration task.

Those skilled in the art should understand that the aforementioned terminal device 101 and server 102 are merely exemplary. Other existing or potentially emerging terminal devices or servers, if applicable to this disclosure, should also be encompassed within the scope of protection of this disclosure, and are hereby incorporated by reference.

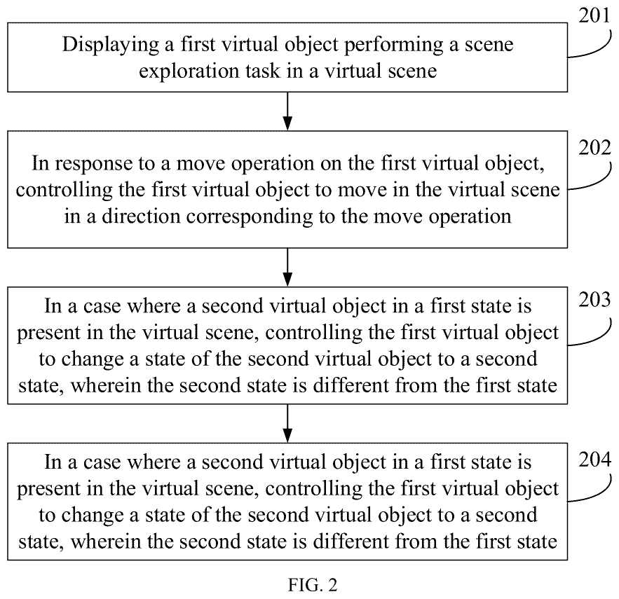

A method for controlling virtual objects is provided in the embodiments of the present disclosure. The method can be applied to the computer system illustrated in FIG. 1 above. Taking the flowchart of the method for controlling virtual objects according to the embodiments of the present disclosure as illustrated in FIG. 2 as an example, the method can be performed by the terminal device 101 in FIG. 1. As illustrated in FIG. 2, the method includes the following processes 201 to 204.

In process 201, a first virtual object performing a scene exploration task in a virtual scene is displayed.

In some embodiments of the present disclosure, a game client capable of providing a virtual scene is installed and operated in a terminal device. The game client can be a client for any game, and embodiments of the present disclosure do not impose any limitations on this. Illustratively, the game client is a business strategy type client. A plurality of virtual objects can be displayed in the virtual scene, wherein different virtual objects can be controlled by different terminal devices or servers. In addition to displaying virtual objects, the virtual scene can also display virtual elements. The virtual elements can be any elements, and embodiments of the present disclosure do not impose any limitations on the virtual elements. Optionally, the virtual elements can include mountains, flatlands, rivers, lakes, oceans, deserts, swamps, quicksand, skies, plants, snowfields, buildings, coal balls, snowmen, and so on. The description of the virtual scene in the present disclosure is merely illustrative and does not impose any limitations on the virtual scene.

Optionally, the display interface of the terminal device displays relevant information of the game client. The relevant information of the game client can be the name of the game client, an icon of the game client, or other information that can represent the game client, which is not limited in the embodiments of the present disclosure. In a case where the game object wants to run the game client, the game object triggers the relevant information of the game client. The terminal device, in response to the trigger operation on the relevant information of the game client, runs the game client and displays the game interface. The game interface displays a first virtual object performing a scene exploration task in the virtual scene. The scene exploration task is a task in the game focused on expanding the field of view and/or collecting resources. The game object can explore the virtual scene by controlling the first virtual object to move and interact within the virtual scene, thereby advancing the game progress, acquiring virtual resources, or unlocking virtual scenes.

Optionally, the virtual scene is covered with granular coverings. The scene exploration task is to eliminate the granular coverings in the virtual scene. Alternatively, a virtual resource is present in the virtual scene, and the scene exploration task is to collect the virtual resource in the virtual scene. Or, a virtual resource is present in the virtual scene, and the virtual resource is covered with granular coverings. The scene exploration task is to eliminate the granular coverings in the virtual scene and collect the virtual resource in the virtual scene.

The trigger operation on the relevant information of the game client includes at least one of the touch operation, gamepad-trigger operation, voice-command-trigger operation, or gesture-trigger operation on the relevant information of the game client. The trigger operation on other contents in the following content are similar to the trigger operation on the relevant information of the game client. In a case where the following content involves trigger operations on other contents, the embodiments of the present disclosure will not be further elaborated.

Optionally, the virtual scene is covered with granular coverings, and the first virtual object holds a first virtual prop, wherein the first virtual prop is used to eliminate granular coverings within the application scope of the first virtual prop.

The granular coverings can be snow, sand, or other substances, which are not limited in embodiments of the present disclosure. The application scope of the first virtual prop is determined based on the position of the first virtual object, a first length, and a first angle. The first length and the first angle are determined based on a target quantity, wherein the target quantity is the number of virtual objects whose state is changed by the first virtual object. Optionally, the application scope of the first virtual prop is a fan-shaped area with the position of the first virtual object as the vertex, the first length as the radius, and the first angle as the arc angle.

Optionally, the more virtual objects whose states are changed by the first virtual object, the larger the target quantity, the greater the first length and the first angle, and the wider the application scope of the first virtual prop. Conversely, the fewer virtual objects whose states are changed by the first virtual object, the smaller the target quantity, the smaller the first length and the first angle, and the narrower the application scope of the first virtual prop.

Illustratively, in a case where three virtual objects are changed in state by the first virtual object, the target quantity is three. Based on the target quantity, the first length is determined to be 1 meter, and the first angle is 30 degrees. Then, the application scope of the first virtual prop is a fan-shaped area with the position of the first virtual object as the vertex, a radius of 1 meter, and an arc angle of 30 degrees.

In these embodiments, the application scope of the first virtual prop is a fan-shaped area with the position of the first virtual object as the vertex, the first length as the radius, and the first angle as the arc angle, thereby greatly expanding the application scope of the first virtual prop. In this way, the first virtual prop held by the first virtual object can cover a large area without the first virtual object moving significantly, thereby improving the efficiency of the first virtual object in performing the scene exploration task.

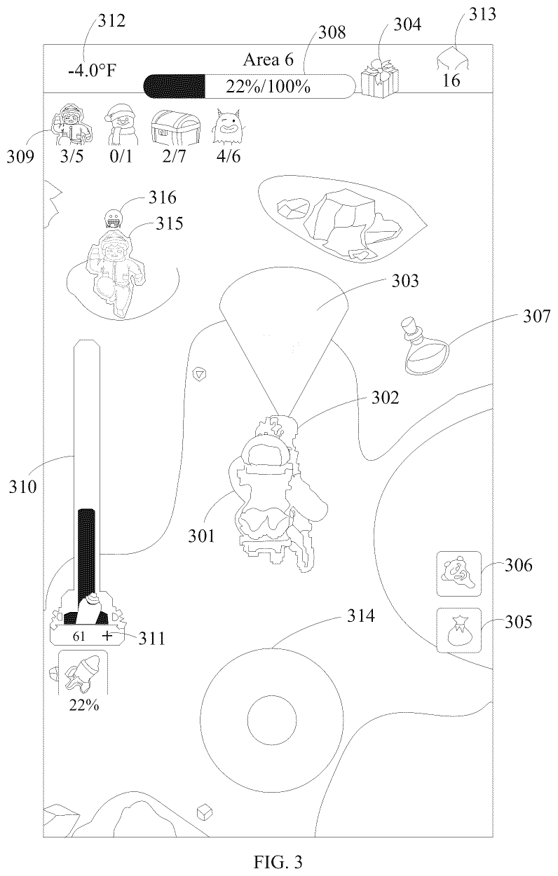

FIG. 3 is a schematic diagram of a game interface according to some embodiments of the present disclosure. A first virtual object 301 is displayed, wherein the first virtual object 301 holds a first virtual prop 302. An application scope of the first virtual prop 302 is 303, and the first virtual prop 302 is used to eliminate granular coverings within the application scope 303 of the first virtual prop 302.

In a possible embodiment, the game interface further displays a task name of the scene exploration task, as illustrated in FIG. 3 where “Area 6” is the task name of the scene exploration task.

In a possible embodiment, the game interface further displays a first control, wherein the first control is used to display resource information of a first virtual resource. The first virtual resource is a virtual resource available in response to completing the scene exploration task, as indicated by 304 in FIG. 3. In response to a trigger operation on the first control, the resource information of the first virtual resource is displayed. The resource information of the first virtual resource can be a resource name of the first virtual resource, a resource icon of the first virtual resource, or other information that can uniquely represent the first virtual resource, which is not limited in the embodiments of the present disclosure.

In this embodiment, by displaying the first control, the game object can view, by triggering the first control, the resource information of the first virtual resource available in response to completing the scene exploration task, such that the game object's desire to explore and enthusiasm for challenges can be effectively stimulated, and the game object is driven to complete the scene exploration task with a clear reward expectation, thereby enhancing the game's fun.

In a possible embodiment, the game interface further displays a second control, wherein the second control is used to display resource information of a second virtual resource. The second virtual resource is a virtual resource perceived by the first virtual object in the virtual scene. As illustrated in FIGS. 3, 305 represents the second control. In response to a trigger operation on the second control, the resource information of the second virtual resource is displayed. The resource information of the second virtual resource can be the resource name of the second virtual resource, the resource icon of the second virtual resource, or other information that can uniquely represent the second virtual resource, which is not limited in the embodiments of the present disclosure.

The second virtual resource can be a virtual resource that the first virtual object has encountered in the virtual scene, a virtual resource that the first virtual object has picked up in the virtual scene, a virtual resource acquired by the first virtual object defeating other virtual objects in the virtual scene, or a virtual resource acquired by the first virtual object opening a virtual treasure chest in the virtual scene. The source of the second virtual resource is not limited in the embodiments of the present disclosure.

In this embodiment, by displaying a second control, the game object can view, by triggering the second control, the resource information of the second virtual resource that has been perceived by the first virtual object, such that the game object's desire to explore and enthusiasm for challenges can be effectively stimulated, and the game object is driven to complete the scene exploration task with a clear reward expectation, thereby enhancing the game's fun.

In a possible embodiment, in a case where the first virtual object completes the scene exploration task, the second virtual resource is transferred to the account of the control object of the first virtual object. That is, only when the first virtual object completes the scene exploration task, can the control object of the first virtual object acquire the virtual resource perceived by the first virtual object in the virtual scene. In this way, game objects can be encouraged to control the first virtual object to complete the scene exploration task, thereby making the game more playable, enhancing game fun, and improving the user retention rate of the game.

Optionally, the process of transferring the second virtual resource to the account of the control object of the first virtual object includes: transmitting object information of the control object of the first virtual object and the resource information of the second virtual resource to the server, and having the server transfer the second virtual resource to the account of the control object of the first virtual object.

Optionally, in a case where the first virtual object completes the scene exploration task, the first virtual resource needs to be transferred to the account of the control object of the first virtual object. The process of transferring the first virtual resource to the account of the control object of the first virtual object is similar to the aforementioned process of transferring the second virtual resource to the account of the control object of the first virtual object, which is not elaborated in the embodiments of the present disclosure.

In a possible embodiment, the game interface further displays a third control, wherein the third control is used to display item information of the first virtual prop and an upgrade control corresponding to the first virtual prop, as indicated by 306 in FIG. 3. In response to a trigger operation on the upgrade control corresponding to the first virtual prop, the first virtual prop is upgraded. The application scope of the upgraded first virtual prop is larger than that of the first virtual prop before upgrade. The item information of the first virtual prop can be the item name of the first virtual prop, the item icon of the first virtual prop, or other information that can uniquely represent the first virtual prop, which is not limited in the embodiments of the present disclosure.

In this embodiment, game objects can expand the application scope of the first virtual prop by upgrading the first virtual prop, such that the gameplay is more diverse, thereby enhancing the game's interaction rate and improving the game's user retention rate.

In a possible embodiment, the third control is further used to display wearing information of the first virtual object and an upgrade control corresponding to the wearing information. In response to upgrading the wearing information of the first virtual object with respect to the upgrade control corresponding to the wearing information, cold resistance of the upgraded wearing information of the first virtual object is greater than that of the wearing information of the first virtual object before upgrade. The wearing information of the first virtual object includes, but is not limited to, information about the clothes and shoes of the first virtual object. The information about the clothes includes, but is not limited to, the name and picture of the clothes. The information about the shoes includes, but is not limited to, the name and picture of the shoes.

In a possible embodiment, the game interface further displays a third virtual resource located in the virtual scene, wherein the third virtual resource is used to provide a gain to the first virtual prop, as indicated by 307 in FIG. 3. In a case where a distance between the first virtual object and the third virtual resource is less than a distance threshold, the first virtual object is displayed picking up the third virtual resource. After the first virtual object picks up the third virtual resource, the application scope of the first virtual prop held by the first virtual object is larger than the application scope of the first virtual prop held by the first virtual object before the first virtual object picked up the third virtual resource.

The distance threshold is determined based on experience, or flexibly adjusted based on an implementation environment, which is not limited in the embodiments of the present disclosure. For example, the distance threshold is 1 meter.

In this embodiment, the game object can expand the application scope of the first virtual prop held by the first virtual object by controlling the first virtual object to pick up the third virtual resource, such that the game is more playable, thereby enhancing the fun of game interaction and improving the user retention rate of the game.

In a possible embodiment, in a case where the distance between the first virtual object and the third virtual resource is less than the distance threshold, subsequent to displaying the first virtual object picking up the third virtual resource, a countdown control can further be displayed, wherein the countdown control is used to indicate the remaining time for the first virtual prop held by the first virtual object to have a gain.

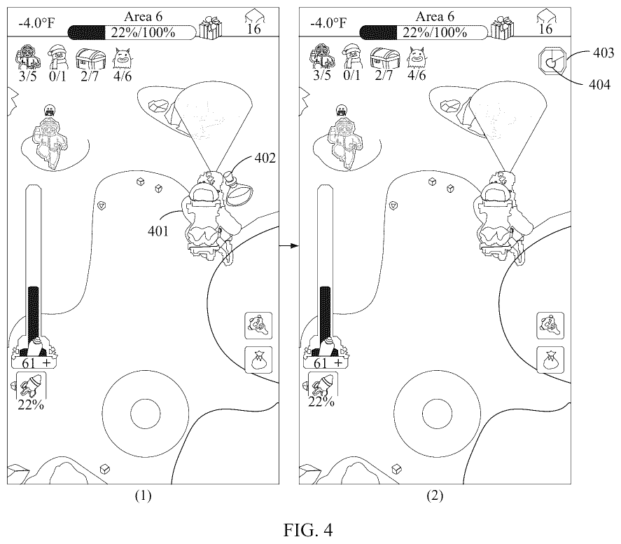

FIG. 4 is a schematic diagram of a countdown control according to some embodiments of the present disclosure. In (1) of FIG. 4, the distance between the first virtual object 401 and the third virtual resource 402 is less than the distance threshold, the first virtual object 401 is displayed picking up the third virtual resource 402, and then (2) of FIG. 4 is displayed, wherein a countdown control 403 is illustrated, and 404 in the countdown control 403 indicates the remaining time for the first virtual prop held by the first virtual object to have a gain.

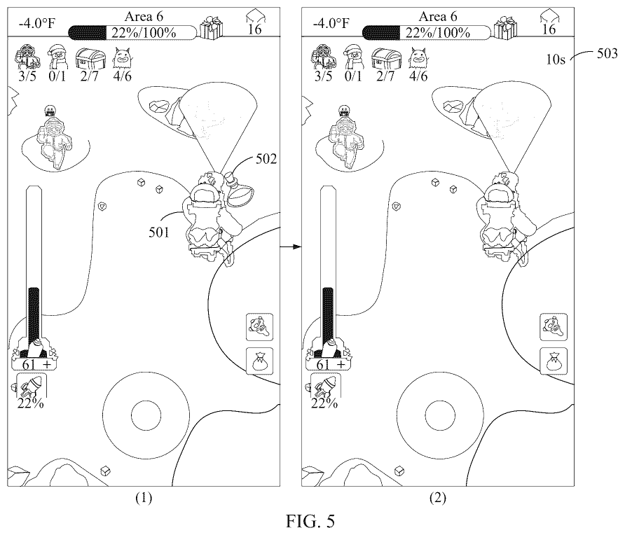

FIG. 5 is a schematic diagram of another countdown control according to some embodiments of the present disclosure. In (1) of FIG. 5, the distance between the first virtual object 501 and the third virtual resource 502 is less than the distance threshold, the first virtual object 501 is displayed picking up the third virtual resource 502, and then (2) of FIG. 5 is displayed, wherein a countdown control 503 is illustrated, that is, the remaining time for the first virtual prop held by the first virtual object to have a gain is 10 s (seconds).

In this embodiment, by displaying the countdown control, the game object is made aware of the remaining time for the first virtual prop held by the first virtual object to have a gain, such that the game object can clearly grasp the status of the first virtual prop, so as to reasonably arrange game strategies and actions, and fully utilize the maximum benefit of the first virtual prop.

In a possible embodiment, the game interface further displays a progress bar, wherein the progress bar is used to indicate a progress level of the first virtual object in the scene exploration task. As illustrated in FIGS. 3, 308 represents the progress bar. Based on the progress bar 308, the progress level of the first virtual object in the scene exploration task is 22%. That is, the first virtual object has completed 22% of the scene exploration task.

In this embodiment, by displaying the progress bar, the game object can intuitively understand the progress situation of the scene exploration task, thereby better planning game behaviors and anticipating game outcomes.

In a possible embodiment, the game interface can further display a first quantity and a second quantity. The first quantity is the total number of virtual objects in the virtual scene that are in a first state, while the second quantity is the number of virtual objects whose state has been changed by the first virtual object. As illustrated in FIG. 3, “5” is the first quantity and “3” is the second quantity, meaning that 5 virtual objects that are in the first state are present in the virtual scene, and the first virtual object has changed the state of 3 virtual objects.

Optionally, the first state can be a frozen state, a state buried by sand, or a state buried by snow, which is not limited in the embodiments of the present disclosure. The virtual object whose state is changed by the first virtual object can be the virtual object whose state is changed by the first virtual object to a thawed state, or the virtual object whose state is changed by the first virtual object to a state not buried by sand, or the virtual object whose state is changed by the first virtual object to a state not buried by snow.

Optionally, the game interface further displays an object icon of a virtual object in the first state, as illustrated in FIG. 3 where 309 represents the object icon of the virtual object in the first state.

In this embodiment, by displaying the first quantity and the second quantity, the game object can clarify the number of virtual objects that have been rescued in the virtual scene, as well as the number of virtual objects that still need to be rescued, such that the sense of achievement and urgency in the game are enhanced, thereby motivating players to engage more deeply in the gameplay.

In a possible embodiment, the virtual scene further includes scene elements, wherein the scene elements include but are not limited to virtual snowmen, a virtual monster, and a virtual treasure chest. The game interface further displays the total number of virtual snowmen in the virtual scene (as indicated by “1” in FIG. 3), the number of virtual snowmen encountered by the first virtual object (as indicated by “0” in FIG. 3), the total number of virtual treasure chests in the virtual scene (as indicated by “7” in FIG. 3), the number of virtual treasure chests opened by the first virtual object (as indicated by “2” in FIG. 3), the total number of virtual monsters in the virtual scene (as indicated by “6” in FIG. 3), and the number of virtual monsters defeated by the first virtual object (as indicated by “4” in FIG. 3). The game interface further displays icons for virtual snowmen, an icon for the virtual monster, and an icon for the virtual treasure chest.

In a possible embodiment, the game interface further displays an energy bar, wherein the energy bar is used to indicate a remaining energy of the first virtual prop held by the first virtual object. In a case where the remaining energy of the first virtual prop held by the first virtual object is not lower than an energy threshold, the first virtual object can change, through the first virtual prop, the state of the second virtual object in the first state. As illustrated in FIGS. 3, 310 represents the energy bar, and it can be seen from the energy bar 310 that the remaining energy of the first virtual prop held by the first virtual object is 61.

The energy threshold is determined based on experience, or flexibly adjusted based on the implementation environment, which is not limited in the embodiments of the present disclosure. Illustratively, the energy threshold is 0.

In this embodiment, the game object is made aware of the remaining energy of the first virtual prop held by the first virtual object through the display of an energy bar, such that the game object knows whether the first virtual object can change, through the first virtual prop, the state of the second virtual object in the first state in the virtual scene.

In a possible embodiment, the game interface further displays an increase control, wherein the increase control is used to indicate increase of the remaining energy of the first virtual prop held by the first virtual object. Optionally, the increase control is displayed in the energy bar, as indicated by 311 in FIG. 3. In response to a trigger operation on the increase control, the remaining energy of the first virtual prop held by the first virtual object is increased by a third amount. The third amount is determined based on experience, or flexibly adjusted based on the implementation environment, which is not limited in embodiments of the present disclosure. Illustratively, the third amount is 10.

Illustratively, the remaining energy of the first virtual prop held by the first virtual object is 61. In response to the trigger operation on the increase control, the remaining energy of the first virtual prop held by the first virtual object is increased by 10, resulting in the remaining energy of the first virtual prop held by the first virtual object becoming 71.

In this embodiment, by displaying the additional control, a method is provided for the game object to increase the remaining energy of the first virtual prop held by the first virtual object, thereby extending the usage time of the first virtual prop held by the first virtual object, and further extending the game time and enhancing game enjoyment.

In a possible embodiment, the game interface further displays the scene temperature of the virtual scene. As illustrated in FIGS. 3, 312 represents the scene temperature of the virtual scene, which is −4.0 degrees Fahrenheit (°F).

In this embodiment, by displaying the temperature of the virtual scene in the game interface, the game object's understanding of the virtual scene can be enhanced, the realism and immersion of the game can be enhanced, the game object is helped to better integrate into the game world, and reference for game strategy may be provided.

In a possible embodiment, the game interface further displays resource information and a fourth quantity of a fourth virtual resource. The fourth quantity is used to indicate the number of fourth virtual resources that have been acquired by the first virtual object. The fourth virtual resource is used to adjust the scene temperature of the virtual scene. The resource information of the fourth virtual resource includes, but is not limited to, the icon and name of the fourth virtual resource. As illustrated in FIGS. 3, 313 represents the resource information of the fourth virtual resource, and “16” represents the fourth quantity, that is, the first virtual object has acquired 16 fourth virtual resources.

In this embodiment, by displaying the resource information and the fourth quantity of the fourth virtual resource, the game object can intuitively understand the acquisition status of the fourth virtual resource that can be used to adjust the scene temperature of the virtual environment, so as to allocate and use the fourth virtual resource reasonably based on game requirements.

Optionally, since the fourth virtual resource is used to adjust the scene temperature of the virtual scene, the game object can adjust the scene temperature of the virtual scene by consuming the fourth virtual resource. In a possible embodiment, in response to a trigger operation on resource information of the fourth virtual resource, the scene temperature of the virtual scene is increased by a reference temperature by consuming a reference quantity of the fourth virtual resource. The reference quantity and the reference temperature are determined based on experience, or flexibly adjusted based on the implementation environment, which is not limited in embodiments of the present disclosure. For example, the reference quantity is 10 and the reference temperature is 1 Fahrenheit, that is, the scene temperature of the virtual scene is increased by 1 Fahrenheit by consuming 10 fourth virtual resources.

Optionally, in response to the trigger operation on the resource information of the fourth virtual resource, in a case where the quantity of the fourth virtual resource already acquired by the first virtual object is not less than the reference quantity, a deduction request is transmitted to the server. The deduction request includes the reference quantity, the resource information of the fourth virtual resource, and object information of the game object. The server deducts the reference quantity of the fourth virtual resource from the account of the game object. In a case where the deduction is successful on the server, the server transmits deduction success information to the terminal device. Subsequently, the terminal device increases the scene temperature of the displayed virtual scene by the reference temperature and decreases the displayed quantity of the fourth virtual resource already acquired by the first virtual object by the reference quantity, thereby achieving the purpose of adjusting the scene temperature of the virtual scene by consuming the fourth virtual resource.

Illustratively, the scene temperature of the virtual scene displayed in the terminal device is −4.0 °F, and the quantity of the fourth virtual resource acquired by the first virtual object is 16. In response to the trigger operation on the resource information of the fourth virtual resource, the terminal device displays the scene temperature of the virtual scene as −3.0 °F and displays the quantity of the fourth virtual resource acquired by the first virtual object as 6.

In process 202, in response to a move operation on the first virtual object, the first virtual object is controlled to move in a direction corresponding to the move operation in the virtual scene.

In a possible embodiment, the game interface further displays a control widget, wherein the control widget is used to control the movement of the first virtual object in the virtual scene, as indicated by 314 in FIG. 3. In response to a drag operation on the control widget, a move operation on the first virtual object is triggered, thereby controlling the first virtual object to move in the direction corresponding to the move operation in the virtual scene. The direction corresponding to the move operation is the direction corresponding to the drag operation.

Optionally, in response to a leftward drag operation on the control widget, the first virtual object is controlled to move leftward in the virtual scene. In response to a rightward drag operation on the control widget, the first virtual object is controlled to move rightward in the virtual scene. In response to a downward drag operation on the control widget, the first virtual object is controlled to move downward in the virtual scene. In response to an upward drag operation on the control widget, the first virtual object is controlled to move upward in the virtual scene. In response to a drag operation in other directions on the control widget, the first virtual object is controlled to move in other directions in the virtual scene.

In a possible embodiment, subsequent to controlling the first virtual object to move in the direction corresponding to the move operation in the virtual scene, the application scope of the first virtual prop is determined based on the position of the first virtual object after the movement; the first virtual object eliminating, through the first virtual prop, the granular coverings within the application scope of the first virtual prop is displayed.

The process of determining the application scope of the first virtual prop based on the position of the first virtual object after the movement includes: determining the application scope of the first virtual prop based on the position of the first virtual object after the movement and the number of virtual objects whose states are changed by the first virtual object.

Optionally, the first length and the first angle are determined based on the number of virtual objects whose states are changed by the first virtual object, and the application scope of the first virtual prop is determined based on the first length, the first angle, and the position of the first virtual object after the movement. This process has been described in process 201 above and will not be elaborated herein any further.

In this embodiment, the first virtual object can be controlled to explore flexibly in the virtual scene, the elimination effect of the first virtual prop can be dynamically triggered based on actual movement, thereby enhancing the strategic and fun aspects of the operation. Additionally, the process of eliminating granular coverings with the first virtual prop is visually present, thereby providing visual feedback and a sense of achievement, while advancing the scene exploration process, unlocking new areas and content, and enhancing the immersion and playability of the game.

In process 203, in a case where a second virtual object in a first state is present in the virtual scene, the first virtual object is controlled to change the state of the second virtual object to a second state, wherein the second state is different from the first state.

In a possible embodiment, in a case where the second virtual object in the first state is present within the virtual scene, the first virtual object is controlled to move towards the second virtual object in the first state, such that the second virtual object in the first state is positioned within the application scope of the first virtual prop. In a case where the second virtual object in the first state is located within the application scope of the first virtual prop, the first virtual object is controlled to change, through the first virtual prop, the state of the second virtual object to the second state. As illustrated in FIGS. 3, 315 represents the second virtual object in the first state.

In a case where the first state is the frozen state, the second state is the thawed state. In a case where the first state is the state buried by sand, the second state is the state not buried by sand. In a case where the first state is the state buried by snow, the second state is the state not buried by snow.

In this embodiment, in a case where the second virtual object in the first state is within the application scope of the first virtual prop held by the first virtual object, the first virtual object is controlled to change, through the first virtual prop, the state of the second virtual object, so as to visualize the way in which the first virtual object changes the state of the second virtual object, thereby enabling the game object to better understand the process of the first virtual object changing the state of the second virtual object.

In a possible embodiment, in a case where the second virtual object in the first state is present in the virtual scene, wherein the second virtual object in the first state is located within the application scope of the first virtual prop, and the remaining energy of the first virtual prop held by the first virtual object is greater than the energy threshold, the first virtual object is controlled to change, through the first virtual prop, the state of the second virtual object to the second state.

In this embodiment, only when the remaining energy of the first virtual prop held by the first virtual object exceeds the energy threshold, can the first virtual object change, through the first virtual prop, the state of the second virtual object, making the way the first virtual object changes the state of the second virtual object more realistic.

In a possible embodiment, in a case where the second virtual object in the first state is present in the virtual scene, wherein the second virtual object in the first state is located within the application scope of the first virtual prop and a first duration has elapsed, the first virtual object is controlled to change, through the first virtual prop, the state of the second virtual object to a third state; in response to a second duration having elapsed, the first virtual object is controlled to change, through the first virtual prop, the state of the second virtual object to the second state.

The first duration and the second duration are determined based on experience, or flexibly adjusted based on the implementation environment, which is not limited in the embodiments of the present disclosure. The first duration and the second duration can be the same or different. For example, the first duration is 2 seconds and the second duration is 3 seconds. The third state is between the first state and the second state. For example, the first state is the frozen state and the second state is the thawed state, then the third state is a semi-thawed state. For another example, the first state is the state buried by snow and the second state is the state not buried by snow, then the third state is a state partially buried by snow. For another example, the first state is the state buried by sand and the second state is the state not buried by sand, then the third state is a state partially buried by sand.

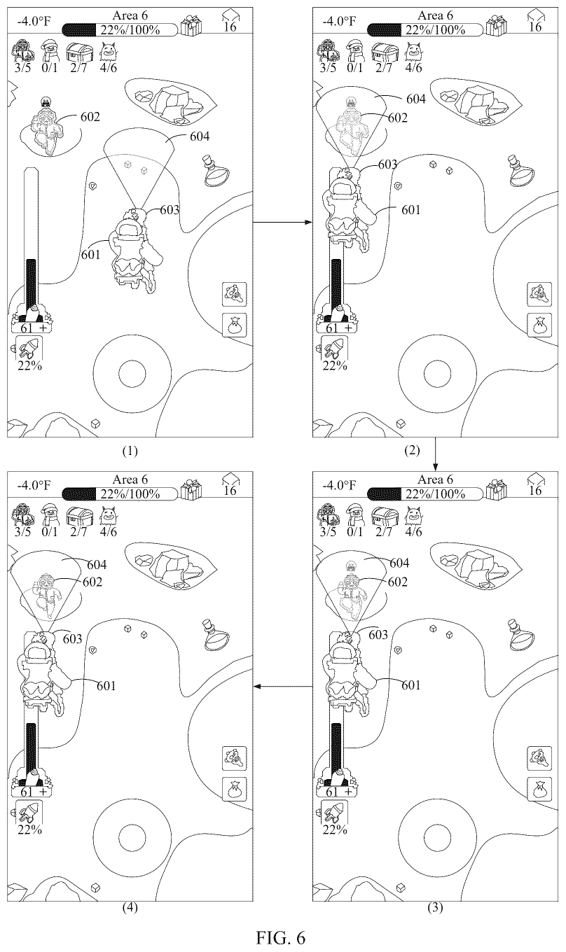

FIG. 6 is a schematic diagram of changing the state of the second virtual object to the second state according to some embodiments of the present disclosure. In (1) of FIG. 6, a first virtual object 601 and a second virtual object 602 in the first state are displayed, wherein the first virtual object 601 holds a first virtual prop 603. The second virtual object 602 is not located within the application scope 604 of the first virtual prop 603 held by the first virtual object 601. In response to a move operation on the first virtual object 601, the first virtual object 601 is controlled to move in a direction corresponding to the move operation, thereby displaying (2) of FIG. 6, where the second virtual object 602 is located within the application scope 604 of the first virtual prop 603 held by the first virtual object 601. Then, the first virtual object 601 is controlled to change, through the first virtual prop 603, the state of the second virtual object 602. After a first duration, (3) of FIG. 6 is displayed, where the first virtual object 601 changes, through the first virtual prop 603, the state of the second virtual object 602 to a third state (semi-thawed state). After a second duration, (4) of FIG. 6 is displayed, where the first virtual object 601 changes, through the first virtual prop 603, the state of the second virtual object 602 to a second state (thawed state).

In this embodiment, by displaying the state of the second virtual object transitioning from the first state to the second state in stages, clear feedback is provided to the game object, allowing for an intuitive observation of the activation process of the first virtual prop, thereby enhancing the sense of participation in the game; in addition, the timeline of state changes is extended, thereby adding strategic depth to the game, and enriching gameplay and entertainment value of the game.

In a possible embodiment, in a case where the second virtual object in the first state is present in the virtual scene, a reference icon can further be displayed at a reference position of the second virtual object in the first state. The reference icon is used to indicate that the second virtual object is in the first state, as indicated by 316 in FIG. 3. The reference position of the second virtual object can be the top of the head of the second virtual object, the left side of the second virtual object, the right side of the second virtual object, or the bottom of the foot of the second virtual object. The reference position of the second virtual object is not limited in the embodiments of the present disclosure.

In process 204, in a case where the second virtual object is in the second state, the second virtual object in the second state is displayed following the first virtual object, wherein the second virtual object assists the first virtual object in performing the scene exploration task.

In a possible embodiment, after the first virtual object changes the state of the second virtual object to the second state, the second virtual object, which is in the second state and holds a second virtual prop, is displayed following the first virtual object. The second virtual prop is used to eliminate granular coverings within the application scope of the second virtual prop. The second virtual object assists, through the second virtual prop, the first virtual object in performing the scene exploration task.

The type of the second virtual prop is the same as that of the first virtual prop, or the type of the second virtual prop is different from that of the first virtual prop, which is not limited in embodiments of the present disclosure. The application scope of the second virtual prop is determined based on the position of the second virtual object holding the second virtual prop, a second length, and a second angle. Optionally, the application scope of the second virtual prop is a fan-shaped area with the position of the second virtual object holding the second virtual prop as the vertex, the second length as the radius, and the second angle as the arc angle. The second length and the second angle are determined based on experience, or flexibly adjusted based on the implementation environment, which is not limited in embodiments of the present disclosure. Illustratively, the second length is 30 centimeters and the second angle is 10 degrees.

In this embodiment, the second virtual object assists, through the second virtual prop, the first virtual object in performing a scene exploration task, such that not only the first virtual object is enabled to receive more assistance when performing the scene exploration task, enhancing the capability to handle complex scenes and difficult challenges, and improving exploration efficiency, but also the interactive elements within the scene are enriched, making the virtual scene more vivid and realistic, thereby increasing the fun and playability of the game, and providing the game object with a richer and more diverse gaming experience.

Optionally, in a case where the first virtual object changes the state of the second virtual object to the second state, the first information is displayed, wherein the first information is a thank-you message from the second virtual object to the first virtual object; in response to a trigger operation on the first information, the second information is displayed, wherein the second information is a reply message from the first virtual object to the second virtual object; in response to a trigger operation on the second information, the second virtual object in the second state is displayed following the first virtual object.

The content of the first information and the content of the second information can be any content, which are not limited in the embodiments of the present disclosure. Optionally, the content of the first information and the content of the second information are determined by the game developer.

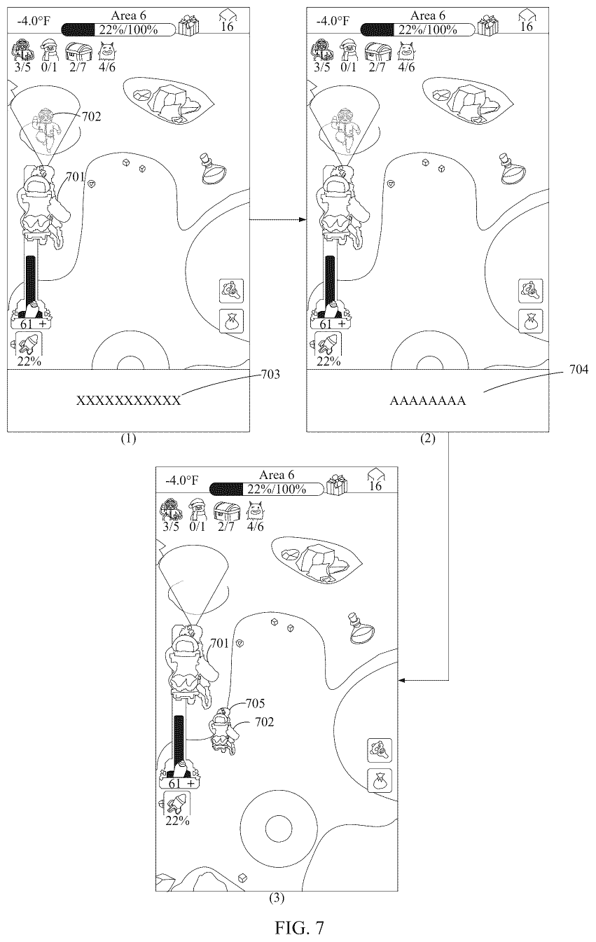

FIG. 7 is a schematic diagram of another game interface according to some embodiments of the present disclosure. In (1) of FIG. 7, a second virtual object 702 whose state has been changed by a first virtual object 701 and first information 703 are displayed. The second virtual object 702 is in the second state. In response to a trigger operation on the first information 703, (2) of FIG. 7 is displayed, displaying second information 704. In response to a trigger operation on the second information 704, (3) of FIG. 7 is displayed, displaying the second virtual object 702 following the first virtual object 701, wherein the second virtual object 702 holds a second virtual prop 705.

In a possible embodiment, after the first virtual object changes the state of the second virtual object to the second state, the application scope of the first virtual prop held by the first virtual object is larger than the application scope of the first virtual prop held by the first virtual object before the first virtual object changes the state of the second virtual object to the second state. Optionally, before the first virtual object changes the state of the second virtual object to the second state, the application scope of the first virtual prop held by the first virtual object is a first application scope, and after the first virtual object changes the state of the second virtual object to the second state, the application scope of the first virtual prop held by the first virtual object is a second application scope, wherein the second application scope is larger than the first application scope.

In this embodiment, after the first virtual object changes the state of the second virtual object to the second state, the application scope of the first virtual prop held by the first virtual object becomes larger. In one aspect, the game object is allowed to intuitively feel the positive feedback brought by the first virtual object's behavior of changing the state of the second virtual object, enhancing the sense of achievement and game motivation, and promoting the game object to control the first virtual object to change the state of more virtual objects in the first state, thereby enhancing the interactivity of the game; in another aspect, the expanded application scope of the first virtual prop enriches the strategic dimension of the game, making subsequent scene exploration tasks more efficient, enhancing the fun and the replay value of the game, and thus increasing the user retention rate of the game.

In a possible embodiment, after the first virtual object changes the state of the second virtual object to the second state in process 203 mentioned above, the second virtual object, which is in the second state and holds the second virtual prop, moves from the position where the second virtual object is located to a first position, and the second virtual object eliminates, through the second virtual prop, the granular coverings present during the movement of the second virtual object from the position where the second virtual object is located to the first position.

The first position is the location of a camp in the game, or the first position is the location of the base corresponding to the second virtual object.

In this embodiment, when the first virtual object changes the state of the second virtual object, the second virtual object either proceeds to the camp on its own or returns to its base. The second virtual object then eliminates, through the second virtual prop, the granular coverings on its way to the camp (or base), thereby assisting the first virtual object in completing the scene exploration task.

In a possible embodiment, after the second virtual object in the second state is displayed following the first virtual object, in a case where the number of second virtual objects following the first virtual object exceeds a first threshold, the application scope of the second virtual prop held by the second virtual object is adjusted. The adjusted application scope of the second virtual prop is larger than the application scope of the second virtual prop before the adjustment.

The first threshold is determined based on experience, or flexibly adjusted based on the implementation environment, which is not limited in the embodiments of the present disclosure. Illustratively, the first threshold is 3.

Optionally, the adjusted application scope of the second virtual prop is determined based on the position of the second virtual object holding the second virtual prop, a third length, and a third angle. Optionally, the adjusted application scope of the second virtual prop is a fan-shaped area with the position of the second virtual object holding the second virtual prop as the vertex, the third length as the radius, and the third angle as the arc angle. The third length and the third angle are determined based on experience, or flexibly adjusted based on the implementation environment, which is not limited in embodiments of the present disclosure. The third length is greater than the second length, and/or the third angle is greater than the second angle.

In this embodiment, in a case where the number of the second virtual objects following the first virtual object exceeds the first threshold, the application scope of the second virtual prop held by the second virtual object is expanded. Since the second virtual object eliminates, through the second virtual prop, granular coverings within the application scope of the second virtual prop, such that the efficiency of the second virtual object in eliminating granular coverings can be improved, thereby enhancing the execution efficiency of the first virtual object in performing the scene exploration task.

In a possible embodiment, virtual objects following the first virtual object are arranged in a target formation. The target formation is a formation selected by the game object. Alternatively, the target formation is a formation determined based on the number of virtual objects following the first virtual object. The way to determine the target formation is not limited in the embodiments of the present disclosure.

Optionally, at least two selectable formations are displayed, wherein the number of selectable formations is the same as the number of virtual objects following the first virtual object; in response to a trigger operation on any one of the selectable formations, the triggered formation is determined as the target formation, and then the virtual objects following the first virtual object is displayed based on the target formation.

Optionally, a formation corresponding to the number of virtual objects following the first virtual object is determined, and any one of the formations corresponding to the number of virtual objects following the first virtual object is determined as the target formation, and then the virtual objects following the first virtual object is displayed based on the target formation.

In a possible embodiment, after the second virtual object in the second state is displayed following the first virtual object, in a case where the number of second virtual objects following the first virtual object reaches a second threshold, a third virtual object is displayed and acquired by combining second virtual objects of the second threshold. The third virtual object holds a third virtual prop, wherein the third virtual prop is used to eliminate granular coverings within an application scope of the third virtual prop. The application scope of the third virtual prop is larger than the sum of the application scopes of the second virtual props held by the second virtual objects of the second threshold.

The second threshold is determined based on experience, or flexibly adjusted based on the implementation environment, which is not limited in the embodiments of the present disclosure. Illustratively, the second threshold is 5.

In this embodiment, in a case where the number of second virtual objects following the first virtual object reaches the second threshold, the second virtual objects following the first virtual object are combined to acquire the third virtual object, wherein the third virtual object holds a third virtual prop with a wider application scope. The third virtual object eliminates, through the third virtual prop, granular coverings within an application scope of the third virtual prop, which not only enhances visual impact and strategic surprise, highlights the charm and power of team collaboration, but also significantly improves the efficiency of scene exploration, accelerates the game process, and brings a more efficient and fulfilling gaming experience to the game object.

In a possible embodiment, after the second virtual object in the second state is displayed following the first virtual object, in a case where the second virtual object possesses a resource exploration capability and a reference virtual resource that is covered with granular coverings is present in the virtual scene, a prompt message is displayed. The prompt message is a message used by the second virtual object for guiding the first virtual object to acquire the reference virtual resource. The type of the reference virtual resource correspond to the type of the second virtual object.

The content of the prompt message can be any information capable of guiding the first virtual object to acquire the reference virtual resource, which is not limited in the embodiments of the present disclosure.

In this embodiment, in a case where the second virtual object possesses the resource exploration capability, a reference virtual resource corresponding to the type of the second virtual object is present in the virtual scene, and the reference virtual resource is covered with granular coverings, the prompt message is displayed, thereby not only strengthening the association and collaboration between the first virtual object and the second virtual object, improving the efficiency of scene exploration, but also enhancing the logic and fun of resource acquisition in the virtual scene, resulting in a smoother and more immersive gaming experience.

In a possible embodiment, after the second virtual object in the second state is displayed following the first virtual object, in response to the first virtual object releasing a first skill towards a target location, and the second virtual object releasing a second skill towards the target location, the granular coverings in a first area is displayed as being eliminated, wherein the first area is determined based on the target location, and the first skill and the second skill belong to different sub-skills within a combination skill.

The target position is a position located at a first distance from the first virtual object in a target direction of the first virtual object. The target direction can be any direction, which is not limited in the embodiments of the present disclosure. Illustratively, the target direction is north. The first distance is determined based on experience, or flexibly adjusted based on the implementation environment, which is not limited in the embodiments of the present disclosure. Illustratively, the first distance is 5 meters. Then, the target position is a position located north of the first virtual object and at a distance of 5 meters from the first virtual object.

Optionally, the target position is a position covered with granular coverings in the virtual scene, and the first area includes an area covered with granular coverings.

The sequence in which the first virtual object releases the first skill towards the target position and the second virtual object releases the second skill towards the target position is not limited in the embodiments of the present disclosure. The first virtual object may release the first skill towards the target position first, followed by the second virtual object releasing the second skill towards the target position; or the second virtual object may release the second skill towards the target position first, followed by the first virtual object releasing the first skill towards the target position; or both the first virtual object and the second virtual object release their respective skills towards the target position simultaneously.

Optionally, the process of determining the first area includes: determining a target length; and determining a circle with the target position as the center and the target length as the radius as the first area. The target length is determined based on experience or adjusted based on the implementation environment, which is not limited in the embodiments of the present disclosure.

Optionally, the game interface further displays a skill release control. In response to a trigger operation on the skill release control, the first virtual object is controlled to release the first skill towards the target position.

Optionally, the first skill released by the first virtual object towards the target position can be a skill that blows up granular coverings within the first area, and the second skill released by the second virtual object towards the target position can be a skill that throws a granular-coverings elimination prop towards the target position. In this way, through the first skill released by the first virtual object and the second skill released by the second virtual object, the granular coverings within the first area can be eliminated.

Alternatively, the first skill released by the first virtual object towards the target location can be a skill that throws a granular-coverings elimination prop towards the target location, and the second skill released by the second virtual object towards the target location can be a skill that throws an acceleration prop towards the target location, which can quickly eliminate the granular coverings within the first area.

The granular-coverings elimination prop is used to eliminate granular coverings. The acceleration prop is used to accelerate the elimination speed of the granular-coverings elimination prop. For example, the granular coverings are a fireball, and the acceleration prop is a match.

Optionally, the first skill released by the first virtual object towards the target position is a skill to transform granular coverings within the first area into a first object, and the second skill released by the second virtual object towards the target position is a skill to eliminate the first object. In this way, the granular coverings within the first area can be eliminated through the first skill released by the first virtual object and the second skill released by the second virtual object.

For example, the first skill can transform granular coverings within the first area into a snowman, or alternatively, the first skill can transform granular coverings within the first area into a frozen person.

In this embodiment, after the first virtual object and the second virtual object release different sub-skills in the combination skill towards the target position, the granular coverings in the first area determined based on this are displayed as being eliminated. In this way, not only the collaborative strategic nature and interactivity between the first virtual object and the second virtual object are enhanced, allowing the game object to feel the charm and power of the combined skill, but also the sense of achievement in the game is enhanced through intuitive visual feedback, gameplay and exploration fun are enriched, and the immersive experience of game objects is optimized.

In a possible embodiment, in a case where the first virtual object changes the state of the second virtual object to the second state, the first virtual object can further be displayed driving a virtual vehicle, and the second virtual object that is in the second state and holds the second virtual prop takes the virtual vehicle. The second virtual object eliminates granular coverings through the second virtual prop. The virtual vehicle is used to accelerate the completion of the scene exploration task by the first virtual object.

The occupant capacity of the virtual vehicle is not less than the sum of the number of the first virtual object and the number of virtual objects whose states are changed by the first virtual object. For example, the number of virtual objects whose states are changed by the first virtual object is three, then the occupant capacity of the virtual vehicle is not less than four. For another example, the number of virtual objects whose states are changed by the first virtual object is six, then the occupant capacity of the virtual vehicle is not less than seven.

Illustratively, the number of virtual objects whose state is changed by the first virtual object is one, the virtual vehicle is a virtual motorcycle. The number of virtual objects whose state is changed by the first virtual object is three, the virtual vehicle is a virtual van.

In a possible embodiment, the second virtual object taking the virtual vehicle is further used to acquire the virtual resource in the virtual scene. Furthermore, the virtual resource acquired by the second virtual object are transferred to a resource collection item corresponding to the first virtual object. The resource collection item corresponding to the first virtual object can be the backpack of the first virtual object, or any other item capable of collecting resources, which is not limited in the embodiments of the present disclosure.

In the aforementioned method, the game object can control the first virtual object performing the scene exploration task within the virtual scene to move around. In the case where the second virtual object in the first state is present within the virtual scene, the first virtual object can be controlled to change the state of the second virtual object to the second state. The second virtual object in the second state follows the first virtual object to assist the first virtual object in performing the scene exploration task, such that the completion of the scene exploration task by the first virtual object can be expedited, thereby enhancing the efficiency of the first virtual object in completing the scene exploration task. Furthermore, this method can enrich the gameplay of the game, increase the interactive fun of the game, and thus enhance the sense of participation and achievement of the game object in the game, thereby improving the interactivity and user retention rate of the game.

Taking the scene exploration task of removing granular coverings (such as snow) as an example, the first virtual object performing a granular-coverings elimination task in the virtual scene is displayed. The first virtual object holds a first virtual prop, wherein the first virtual prop is used to eliminate granular coverings. In response to a move operation on the first virtual object, the first virtual object is controlled to move in the direction corresponding to the move operation in the virtual scene, and eliminate the granular coverings within the application scope of the first virtual prop. In a case where the second virtual object in the frozen state is present in the virtual scene, and the second virtual object in the frozen state is located within the application scope of the first virtual prop held by the first virtual object, the first virtual object is controlled to change the state of the second virtual object to the thawed state. In a case where the second virtual object is in the thawed state, the second virtual object, which is in the thawed state and holds a second virtual prop, is displayed follows the first virtual object. The second virtual prop is used to eliminate the granular coverings, and the second virtual object assists, through the second virtual prop, the first virtual object in performing the granular covering removal task.

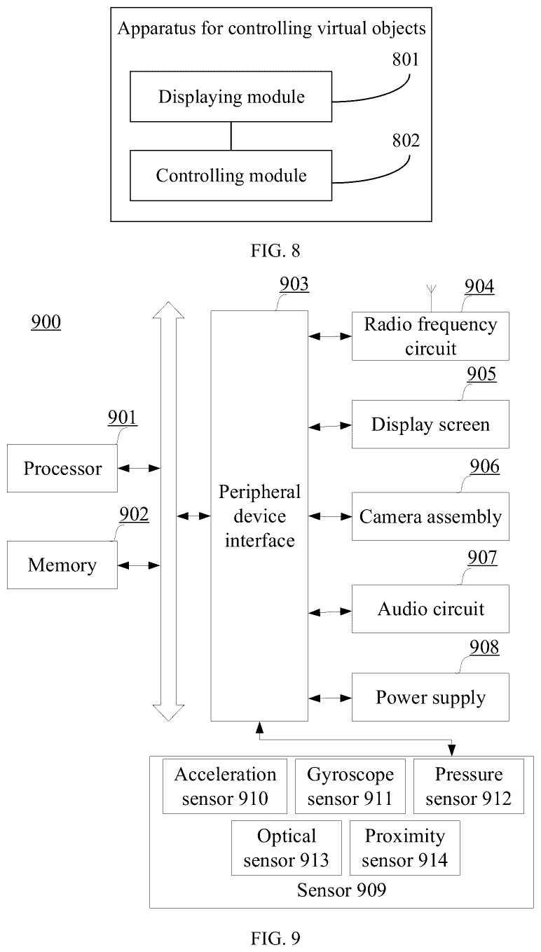

FIG. 8 illustrates a structural schematic diagram of an apparatus for controlling virtual objects according to some embodiments of the present disclosure. As illustrated in FIG. 8, the apparatus includes:
a displaying module 801, configured to display a first virtual object performing a scene exploration task in a virtual scene; and
a controlling module 802, configured to control the first virtual object to move in a direction corresponding to a move operation in the virtual scene in response to the move operation on the first virtual object; wherein
the controlling module 802 is further configured to, in a case where a second virtual object in a first state is present in the virtual scene, control the first virtual object to change the state of the second virtual object to a second state, wherein the second state is different from the first state; and
the displaying module 801 is further configured to, in a case where the second virtual object is in the second state, display the second virtual object in the second state following the first virtual object, wherein the second virtual object assists the first virtual object in performing the scene exploration task.

In a possible embodiment, the virtual scene is covered with granular coverings, and the first virtual object holds a first virtual prop, wherein the first virtual prop is used to eliminate granular coverings within an application scope of the first virtual prop;
the controlling module 802 is configured to control the first virtual object to change, through the first virtual prop, the state of the second virtual object to a second state in a case where the second virtual object in the first state is present in the virtual scene, and the second virtual object in the first state is located within the application scope of the first virtual prop; and
the displaying module 801 is configured to, in a case where the second virtual object is in the second state, display the second virtual object in the second state following the first virtual object while holding the second virtual prop, wherein the second virtual prop is used to eliminate granular coverings within the application scope of the second virtual prop, and the second virtual object assists, through the second virtual prop, the first virtual object in performing the scene exploration task.

In a possible embodiment, the application scope of the first virtual prop is determined based on the position of the first virtual object, a first length, and a first angle, wherein the first length and the first angle are determined based on a target quantity, wherein the target quantity is the quantity of virtual objects whose states are changed by the first virtual object.

In a possible embodiment, the controlling module 802 is configured to control the first virtual object to change, through the first virtual prop, the state of the second virtual object to a third state in a case where the second virtual object in the first state is present in the virtual scene, the second virtual object in the first state is located within the application scope of the first virtual prop, and a first duration has elapsed, wherein the third state is between the first state and the second state; and in response to a second duration having elapsed, control the first virtual object to change, through the first virtual prop, the state of the second virtual object to the second state.

In a possible embodiment, the virtual scene is covered with granular coverings; the first virtual object holds a first virtual prop, wherein the first virtual prop is used to eliminate granular coverings within the application scope of the first virtual prop; and the apparatus further includes: a determining module, configured to determine the application scope of the first virtual prop based on the position of the first virtual object after movement; wherein the displaying module 801 is further configured to display the first virtual object eliminating, through the first virtual prop, granular coverings within the application scope of the first virtual prop.

In a possible embodiment, the virtual scene is covered with granular coverings; the first virtual object holds a first virtual prop, wherein the first virtual prop is used to eliminate granular coverings within an application scope of the first virtual prop; and after the first virtual object changes the state of the second virtual object to the second state, the application scope of the first virtual prop held by the first virtual object is larger than the application scope of the first virtual prop held by the first virtual object before the first virtual object changes the state of the second virtual object to the second state.

In a possible embodiment, the apparatus further includes: an adjusting module, configured to adjust the application scopes of second virtual props held by the second virtual objects in a case where the number of second virtual objects following the first virtual object is greater than a first threshold, wherein the adjusted application scopes of the second virtual props are larger than the application scopes of the second virtual props before adjustment.

In a possible embodiment, the displaying module 801 is further configured to display a third virtual object acquired by combining the second virtual objects of the second threshold in a case where the number of second virtual objects following the first virtual object reaches the second threshold, wherein the third virtual object holds a third virtual prop, wherein the third virtual object is used to eliminate granular coverings within the application scope of the third virtual prop, and an application scope of the third virtual prop is larger than the sum of the application scopes of the second virtual props held by the second virtual objects of the second threshold.

In a possible embodiment, the displaying module 801 is further configured to display a prompt message in a case where the second virtual object has a resource exploration capability and a reference virtual resource covered with granular coverings is present in the virtual scene, wherein the prompt message is a message used by the second virtual object for guiding the first virtual object to acquire the reference virtual resource, and the type of the reference virtual resource correspond to the type of the second virtual object.

In a possible embodiment, the displaying module 801 is further configured to display granular coverings in a first area as being eliminated in response to the first virtual object releasing a first skill towards a target position and the second virtual object releasing a second skill towards the target position, wherein the first area is determined based on the target position, and the first skill and the second skill belong to different sub-skills within a combination skill.

In the aforementioned apparatus, the game object can control the first virtual object performing the scene exploration task in the virtual scene to move within the virtual scene. In a case where the second virtual object in the first state is present within the virtual scene, the first virtual object can be controlled to change the state of the second virtual object to the second state. The second virtual object in the second state follows the first virtual object to assist the first virtual object in performing the scene exploration task, thereby accelerating the completion of the scene exploration task by the first virtual object and enhancing the efficiency of the first virtual object in completing the scene exploration task. Furthermore, the apparatus can enrich the gameplay of the game, increase the interactive fun of the game, and enhance the sense of participation and achievement of the game object in the game, thereby improving the interactivity of the game and user retention rate.

It should be understood that the apparatus provided above is exemplified only based on the division of the aforementioned functional modules when achieving its functions. In practice, the aforementioned functions can be allocated to different functional modules as needed, that is, the internal structure of the apparatus can be divided into different functional modules to accomplish all or part of the functions described above. Additionally, the apparatus according to the aforementioned embodiments and the method embodiments belong to the same concept, and the specific implementation process is detailed in the method embodiments, which will not be further elaborated here.

FIG. 9 illustrates a structural block diagram of a terminal device 900 according to some embodiments of the present disclosure. The terminal device 900 can be any electronic device product capable of human-computer interaction with users through one or more methods such as a keyboard, a touchpad, a remote control, voice interaction, or a handwriting device, for example, a Personal Computer (PC), a mobile phone, a smartphone, a Personal Digital Assistant (PDA), a wearable device, a Pocket PC (PPC), a tablet computer, a smart car machine, a smart TV, a smart speaker, a smart watch, or the like.

Generally, the terminal device 900 includes a processor 901 and a memory 902.

The processor 901 can include one or more processing cores, such as a 4-core processor or an 8-core processor, etc. The processor 901 can be implemented using at least one hardware form among Digital Signal Processing (DSP), Field-Programmable Gate Array (FPGA), and Programmable Logic Array (PLA). The processor 901 can further include a main processor and a co-processor. The main processor is a processor used for processing data in an awake state, also known as Central Processing Unit (CPU). The co-processor is a low-power processor used for processing data in a standby state. In some embodiments, the processor 901 can be integrated with a Graphics Processing Unit (GPU), wherein the GPU is responsible for rendering and drawing the content required to be displayed on the display screen. In some embodiments, the processor 901 can further include an Artificial Intelligence (AI) processor, wherein the AI processor is used for processing computational operations related to machine learning.

The memory 902 may include one or more computer-readable storage medium, wherein the computer-readable storage may be non-transitory. The memory 902 may further include a high-speed random access memory, as well as a non-volatile memory, such as one or more magnetic disk storage devices and flash memory storage devices. In some embodiments, the non-transitory computer-readable storage medium in the memory 902 is used to store at least one instruction, wherein the at least one instruction, when executed by the processor 901, causes the processor 901 to perform the method for controlling virtual objects according to the method embodiments in this disclosure.

In some embodiments, the terminal device 900 can optionally include: a peripheral device interface 903 and at least one peripheral device. The processor 901, the memory 902, and the peripheral device interface 903 can be connected via a bus or a signal line. Each peripheral device can be connected to the peripheral device interface 903 via a bus, a signal line, or a circuit board. Specifically, the peripheral devices include at least one of: a radio frequency circuit 904, a display screen 905, a camera assembly 906, an audio circuit 907, or a power supply 908.

The peripheral device interface 903 can be utilized to connect at least one Input/Output (I/O) related peripheral device to the processor 901 and the memory 902. In some embodiments, the processor 901, memory 902, and peripheral device interface 903 are integrated onto the same chip or a circuit board; in other embodiments, any one or two of the processor 901, memory 902, and peripheral device interface 903 can be implemented on separate chips or circuit boards, which is not limited in the embodiments.

The radio frequency (RF) circuit 904 is configured to receive and transmit RF signals, also known as electromagnetic signals. The RF circuit 904 communicates with a communication network and another communication device over electromagnetic signals. The RF circuit 904 converts an electrical signal into an electromagnetic signal for transmission, or converts a received electromagnetic signal into an electrical signal. Optionally, the RF circuit 904 includes: an antenna system, an RF transceiver, one or more amplifiers, a tuner, an oscillator, a digital signal processor, a codec chipset, a user identity module card, or the like. The RF circuit 904 can communicate with another terminal device over at least one wireless communication protocol. The wireless communication protocol includes but is not limited to: the World Wide Web, a metropolitan area network, an intranet, various generations of mobile communication networks (2G, 3G, 4G, and 5G), a wireless local area network, and/or Wi-Fi (Wireless Fidelity) networks. In some embodiments, the RF circuit 904 may further include a circuit related to Near Field Communication (NFC), which is not limited in the present disclosure.

The display screen 905 is used to display the User Interface (UI). The UI can include graphics, text, icons, videos, and any combination thereof. In a case where the display screen 905 is a touch display screen, the display screen 905 also has the ability to collect touch signals on or above its surface. These touch signals can be input as control signals to the processor 901 for processing. At this time, the display screen 905 can further be used to provide a virtual button and/or a virtual keyboard, also known as a soft button and/or a soft keyboard. In some embodiments, the display screen 905 can be one, disposed on the front panel of the terminal device 900; in other embodiments, the display screen 905 can be at least two, disposed on different surfaces of the terminal device 900 or in a folding design; in yet other embodiments, the display screen 905 can be a flexible display screen, disposed on the curved surface or folding surface of the terminal device 900. Furthermore, the display screen 905 can be arranged in a non-rectangular irregular shape, also known as a shaped screen. The display screen 905 can be fabricated using materials such as Liquid Crystal Display (LCD) and Organic Light-Emitting Diode (OLED).

The camera assembly 906 is used to capture images or videos. Optionally, the camera assembly 906 includes a front camera and a rear camera. Typically, the front camera is disposed on the front panel of the terminal device 900, and the rear camera is disposed on the back of the terminal device 900. In some embodiments, the rear camera includes at least two types, wherein each of the at least two rear cameras is one of a main camera, a depth-of-field camera, a wide-angle camera, or a telephoto camera, so as to achieve the background blurring function by integrating the main camera and the depth-of-field camera, the panoramic shooting function, the Virtual Reality (VR) shooting function, or other integrated shooting functions by integrating the main camera and the wide-angle camera. In some embodiments, the camera assembly 906 may further include a flashlight. The flashlight can be a single color temperature flashlight or a dual color temperature flashlight. The dual color temperature flashlight refers to a combination of a warm light flashlight and a cool light flashlight, which can be used for light compensation under different color temperatures.

The audio circuit 907 can include a microphone and a speaker. The microphone is used to collect sound waves from the user and the environment, and convert the sound waves into electrical signals that are input to the processor 901 for processing, or input to the radio frequency circuit 904 to enable voice communication. For stereo sound collection or noise reduction purposes, the number of the microphone can be greater than one, each located at different parts of the terminal device 900. The microphone can also be an array microphone or an omnidirectional collection microphone. The speaker is used to convert electrical signals from the processor 901 or the radio frequency circuit 904 into sound waves. The speaker can be a traditional thin-film speaker or a piezoelectric ceramic speaker. In a case where the speaker is the piezoelectric ceramic speaker, the speaker can not only convert electrical signals into sound waves that are audible to humans, but also convert electrical signals into sound waves that are inaudible to humans for purposes such as ranging. In some embodiments, the audio circuit 907 can also include an earphone jack.

The power supply 908 is used to supply power to various components in the terminal device 900. The power supply 908 can be an alternating current (AC) power supply, a direct current (DC) power supply, a disposable battery, or a rechargeable battery. In a case where the power supply 908 includes the rechargeable battery, the rechargeable battery can be a wired charging battery or a wireless charging battery. The wired charging battery is a battery that is charged via a wired line, while the wireless charging battery is a battery that is charged via a wireless coil. The rechargeable battery can further be used to support fast charging technology.

In some embodiments, the terminal device 900 further includes one or more sensors 909. The one or more sensors 909 include, but are not limited to: an acceleration sensor 910, a gyroscope sensor 911, a pressure sensor 912, an optical sensor 913, and a proximity sensor 914.

The acceleration sensor 910 can detect the magnitude of acceleration along the three coordinate axes of the coordinate system established by the terminal device 900. For example, the acceleration sensor 910 can be utilized to measure the components of gravitational acceleration along these three axes. Based on the gravitational acceleration signals collected by the acceleration sensor 910, the processor 901 can control the display screen 905 to present the user interface in either landscape or portrait view. Additionally, the acceleration sensor 910 can be employed for gaming or the collection of user motion data.

The gyroscope sensor 911 can detect the body orientation and rotation angle of the terminal device 900. The gyroscope sensor 911 can collaborate with the acceleration sensor 910 to collect 3D motions of the user on the terminal device 900. Based on the data collected by the gyroscope sensor 911, the processor 901 can implement the following functions: motion sensing (such as changing the UI based on the user's tilt operation), image stabilization during shooting, game control, and inertial navigation.

The pressure sensor 912 can be positioned on the side frame of the terminal device 900 and/or beneath the display screen 905. In a case where the pressure sensor 912 is positioned on the side frame of the terminal device 900, the pressure sensor 912 can detect the user's grip signal on the terminal device 900. The processor 901 then identifies the user's left or right hand or performs a shortcut operation based on the grip signal collected by the pressure sensor 912. In a case where the pressure sensor 912 is positioned beneath the display screen 905, the processor 901 controls an operable control on the UI interface based on the user's pressure operation on the display screen 905. The operable control includes at least one of a button control, a scroll bar control, an icon control, or a menu control.

The optical sensor 913 is used to collect the ambient light intensity. In an embodiment, the processor 901 can control the display luminance of the display screen 905 based on the ambient light intensity collected by the optical sensor 913. Specifically, in a case where the ambient light intensity is high, the display luminance of the display screen 905 is increased; and in a case where the ambient light intensity is low, the display luminance of the display screen 905 is decreased. In another embodiment, the processor 901 can further dynamically adjust the shooting parameters of the camera assembly 906 based on the ambient light intensity collected by the optical sensor 913.

The proximity sensor 914, also known as a distance sensor, is typically disposed on the front panel of the terminal device 900. The proximity sensor 914 is used to measure the distance between the user and the front of the terminal device 900. In an embodiment, in a case where the proximity sensor 914 detects that the distance between the user and the front of the terminal device 900 is decreasing, the processor 901 controls the display screen 905 to switch from an on-screen state to an off-screen state; and in a case where the proximity sensor 914 detects that the distance between the user and the front of the terminal device 900 is increasing, the processor 901 controls the display screen 905 to switch from an off-screen state to an on-screen state.

Those skilled in the art can understand that the structure illustrated in FIG. 9 does not constitute a limitation on the terminal device 900, and the terminal device 900 may include more or fewer components than illustrated, or a combination of certain components, or adopt different component arrangements.

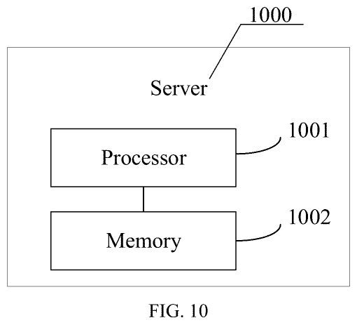

FIG. 10 is a structural schematic diagram of a server according to some embodiments of the present disclosure. The server 1000 may vary significantly due to different configurations or performances, and may include one or more processors (Central Processing Units, CPU) 1001 and one or more memories 1002. At least one program code is stored in the one or more memories 1002, and the at least one program code, when loaded and executed by the one or more processors 1001, causes the one or more processors 1001 to perform the method for controlling virtual objects according to the various method embodiments described above. The server 1000 may further have a wired or wireless network interface, a keyboard, an input/output interface, and other components for input/output. The server 1000 may further include other components for implementing device functions, which will not be described in detail here.

In exemplary embodiments, a computer-readable storage medium is further provided, in which at least one program code is stored. The at least one program code, when loaded and executed by a processor, causes the computer to perform any of the above-mentioned method for controlling virtual objects.

Alternatively, the aforementioned computer-readable storage medium can be a read-only memory (ROM), a random access memory (RAM), a compact disc read-only memory (CD-ROM), a magnetic tape, a floppy disk, an optical data storage device, or the like.

In exemplary embodiments, a computer program or a computer program product is further provided, in which at least one computer instruction is stored. The at least one computer instruction, when loaded and executed by a processor, causes the computer to perform any of the above-mentioned method for controlling virtual objects.

It should be noted that the information (including but not limited to user device information, user personal information, or the like), data (including but not limited to data used for analysis, stored data, displayed data, or the like), and signals involved in this disclosure are all authorized by the users or fully authorized by all parties, and the collection, use, and processing of relevant data must comply with relevant laws, regulations, and standards of relevant countries and regions.

It should be understood that “a plurality of” mentioned in this article refers to two or more. The term “and/or” herein merely describes an association relationship between associated objects, indicating three types of relationships. For example, the phrase “A and/or B” means (A), (B), or (A and B). The character “/” herein generally represents an “or” relationship between the associated objects.

Described above are merely exemplary embodiments of the present disclosure and are not intended to limit the present disclosure. Any modifications, equivalent substitutions, improvements, or the like, made within the spirit and principle of the present disclosure should fall within the protection scope of the present disclosure.

1. A method for controlling virtual objects, comprising:
displaying a first virtual object performing a scene exploration task in a virtual scene;
in response to a move operation on the first virtual object, controlling the first virtual object to move in a direction corresponding to the move operation in the virtual scene;
in a case where a second virtual object in a first state is present in the virtual scene, controlling the first virtual object to change a state of the second virtual object to a second state, wherein the second state is different from the first state;
in a case where the second virtual object is in the second state, displaying the second virtual object in the second state following the first virtual object, wherein the second virtual object assists the first virtual object in performing the scene exploration task; and
in a case where a number of second virtual objects following the first virtual object reaches a second threshold, displaying a third virtual object acquired by combining the second virtual objects of the second threshold, wherein the third virtual object holds a third virtual prop, wherein the third virtual prop is used to eliminate granular coverings within an application scope of the third virtual prop, the application scope of the third virtual prop being larger than a sum of application scopes of second virtual props held by the second virtual objects of the second threshold.

2. The method according to claim 1, wherein the virtual scene is covered with granular coverings, and the first virtual object holds a first virtual prop, wherein the first virtual prop is used to eliminate granular coverings within an application scope of the first virtual prop;
in the case where the second virtual object in the first state is present in the virtual scene, controlling the first virtual object to change the state of the second virtual object to the second state comprises:
in a case where the second virtual object in the first state is present in the virtual scene, and the second virtual object in the first state is located within the application scope of the first virtual prop, controlling the first virtual object to change, through the first virtual prop, the state of the second virtual object to the second state; and
in the case where the second virtual object is in the second state, displaying the second virtual object in the second state following the first virtual object comprises:
in the case where the second virtual object is in the second state, displaying the second virtual object following the first virtual object, wherein the second virtual object is in the second state and holds a second virtual prop, wherein the second virtual prop is used to eliminate granular coverings within the application scope of the second virtual prop, and the second virtual object assists, through the second virtual prop, the first virtual object in performing the scene exploration task.

3. The method according to claim 2, wherein the application scope of the first virtual prop is determined based on a position of the first virtual object, a first length, and a first angle, wherein the first length and the first angle are determined based on a target quantity, wherein the target quantity is a quantity of virtual objects whose states are changed by the first virtual object.

4. The method according to claim 2, wherein in the case where the second virtual object in the first state is present in the virtual scene, and the second virtual object in the first state is located within the application scope of the first virtual prop, controlling the first virtual object to change, through the first virtual prop, the state of the second virtual object to the second state comprises:
in a case where the second virtual object in the first state is present in the virtual scene, the second virtual object in the first state is located within the application scope of the first virtual prop and a first duration has elapsed, controlling the first virtual object to change, through the first virtual prop, the state of the second virtual object to a third state, wherein the third state is between the first state and the second state; and
in response to a second duration having elapsed, controlling the first virtual object to change, through the first virtual prop, the state of the second virtual object to the second state.

5. The method according to claim 1, wherein the virtual scene is covered with granular coverings; the first virtual object holds a first virtual prop, wherein the first virtual prop is used to eliminate granular coverings within an application scope of the first virtual prop; and
subsequent to controlling the first virtual object to move in the direction corresponding to the move operation in the virtual scene in response to the move operation on the first virtual object, the method further comprises:
determining an application scope of the first virtual prop based on a position of the first virtual object after movement; and
displaying the first virtual object eliminating, through the first virtual prop, the granular coverings within the application scope of the first virtual prop.

6. The method according to claim 1, wherein the virtual scene is covered with granular coverings; the first virtual object holds a first virtual prop, wherein the first virtual prop is used to eliminate granular coverings within an application scope of the first virtual prop; and
after the first virtual object changes the state of the second virtual object to the second state, the application scope of the first virtual prop held by the first virtual object is larger than that before the first virtual object changes the state of the second virtual object to the second state.

7. The method according to claim 1, wherein subsequent to displaying the second virtual object in the second state following the first virtual object in the case where the second virtual object is in the second state, the method further comprises:
in a case where the number of second virtual objects following the first virtual object is greater than a first threshold, adjusting the application scopes of the second virtual props held by the second virtual objects, wherein adjusted application scopes of the second virtual props are larger than their original application scopes before adjustment.

8. The method according to claim 1, wherein subsequent to displaying the second virtual object in the second state following the first virtual object in the case where the second virtual object is in the second state, the method further comprises:
in a case where the second virtual object possesses a resource exploration capability and a reference virtual resource that is covered with granular coverings is present in the virtual scene, displaying a prompt message, wherein the prompt message is a message used by the second virtual object for guiding the first virtual object to acquire the reference virtual resource, and a type of the reference virtual resource corresponds to a type of the second virtual object.

9. The method according to claim 1, wherein subsequent to displaying the second virtual object in the second state following the first virtual object in the case where the second virtual object is in the second state, the method further comprises:
in response to the first virtual object releasing a first skill towards a target location and the second virtual object releasing a second skill towards the target location, displaying granular coverings in a first area as eliminated, wherein the first area is determined based on the target location, and the first skill and the second skill belong to different sub-skills within a combination skill.

10. An apparatus for controlling virtual objects, comprising:
a displaying module, configured to display a first virtual object performing a scene exploration task in a virtual scene; and
a controlling module, configured to control the first virtual object to move in the virtual scene in a direction corresponding to a move operation in response to the move operation on the first virtual object; wherein
the controlling module is further configured to control the first virtual object to change a state of the second virtual object to a second state in the virtual scene in a case where the second virtual object is in a first state, wherein the second state is different from the first state;
the displaying module is further configured to, in a case where the second virtual object is in the second state, display the second virtual object in the second state following the first virtual object, wherein the second virtual object assists the first virtual object in performing the scene exploration task; and
the displaying module is further configured to, in a case where a number of second virtual objects following the first virtual object reaches a second threshold, display a third virtual object acquired by combining the second virtual objects of the second threshold, wherein the third virtual object holds a third virtual prop, wherein the third virtual prop is used to eliminate granular coverings within an application scope of the third virtual prop, the application scope of the third virtual prop being larger than a sum of application scopes of second virtual props held by the second virtual objects of the second threshold.

11. A computer device, wherein the computer device comprises a processor and a memory, wherein the memory stores at least one program code, which when loaded and executed by the processor, causes the computer device to perform the method for controlling virtual objects as defined in claim 1.

12. A computer-readable storage medium, wherein the computer-readable storage medium stores at least one program code, which when loaded and executed by a processor, causes a computer to perform the method for controlling virtual objects as defined in claim 1.

13. A computer program product, wherein the computer program product stores at least one computer instruction, which when loaded and executed by a processor, causes a computer to perform the method for controlling virtual objects as defined in claim 1.
